(19) United States
(12) Patent Application Publication
(10) Pub. No.: US 2007/0024515 A1
(43) Pub. Date: Feb. 1, 2007

(54) Coplanar waveguide fed dual-band slot antenna and method of operature therefore

(76) Inventor: Seong-Youp Suh, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/193,047

(22) Filed: Jul. 28, 2005

(51) Int. Cl. H01Q 13/10

(52) U.S. Cl. 343/767

(57) ABSTRACT

An embodiment of the present invention provides an antenna, comprising a substrate, a metallic component printed on the substrate, a main radiating slot etched into the metallic component, the main radiating slot fed by a coplanar waveguide, and at least one additional slot etched next to the main radiating slot. An embodiment of the present invention further provides a method of manufacturing an antenna, comprising printing a metallic component on a substrate, etching a main radiating slot into the metallic component, the main radiating slot fed by a coplanar waveguide, and etching at least one additional slot in proximity to the main radiating slot.

### BACKGROUND

Wireless local area networks (WLAN) are becoming prevalent in many environments. To facilitate implementation of WLAN, the Institute of Electrical and Electronic Engineers (IEEE) has developed standards and protocols for such networks. These standards are commonly referred to as the IEEE 802.11 standards (802.11a, 802.11b, and so forth).

An 802.11 WLAN network is typically made up of a group of nodes forming a cell called Basic Service Set (BSS). A node may be an access point (AP) or a station (STA). There is constant effort to improve the quality and bandwidth of these wireless networks. Since RF energy is emitted from and received by an antenna associated with a transceiver, improvements to antenna technology are greatly desired. Further, the ability to transmit and receive a plurality of frequencies is beneficial to WLANs.

Currently, there are improved antennas such as slot antennas operating in the dual-band, however, these antennas use a switch in the middle of the slot to generate a dual-mode and thus cannot provide concurrent operation in the dual-band.

Thus, a strong need exists for an improved antenna that is capable of multiple band operation without a switch in wireless networks.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates the dual-band slot antenna of one embodiment of the present invention;

FIG. 2 graphically illustrates the computed return loss (referenced to 50Ω) of one embodiment of the present invention; and

FIG. 3 depicts a computed radiation pattern at 2.5 GHz of one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like).

An embodiment of the present invention provides a new antenna element for wireless networks, such as but not limited to, WLAN applications providing dual-band in the frequency of 2.4 and 5.5 GHz simultaneously. The dual-band WLAN antenna may be achieved by using a plurality, such as by way of example and not limitation, using two slots made in the copper plate printed on a dielectric substrate. It is understood that the present invention is not limited to the metal copper for the plate. A main slot may be fed by a coplanar waveguide and the second slot may be etched next to the main radiating slot. The compact form factor of the slot antenna enables it to be easily installed in the lid of a laptop computer. The slot antenna may also provide a bi-directional pattern with half-power beam width of 80° for each beam, so the antenna may have angular coverage of about 160° in a single element. Further, the printed coplanar waveguide feed system enables to print the antenna on the same printed circuit board of radio transceiver.

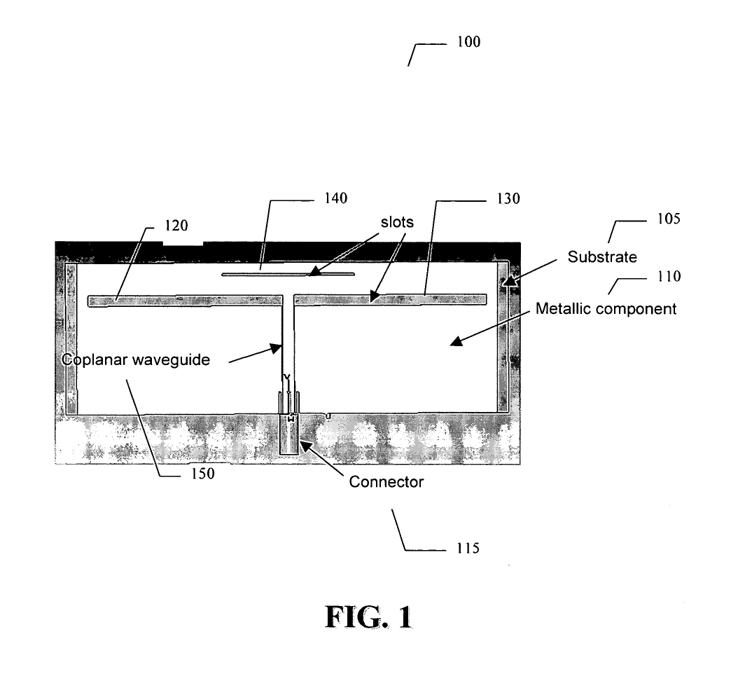

Turning now to the figures, FIG. 1, generally at 100, illustrates the dual-band slot antenna of one embodiment of the present invention. Metallic component 110 is shown on substrate 105 with slots 120, 130 and 140 etched therein. Coplanar waveguide 150 feeds the slots 120, 130, and 140 and is connected to an energy source by connector 115.

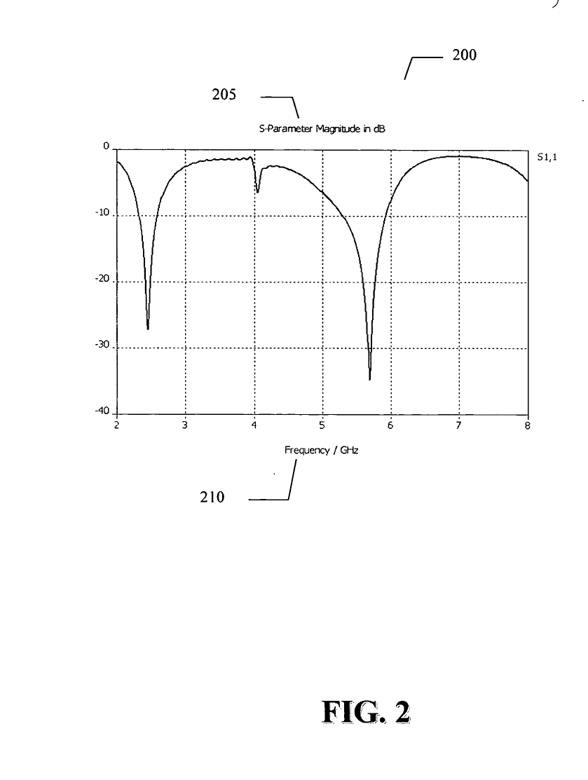

FIG. 2 graphically, at 200, illustrates the computed return loss (referenced to 50Ω) of one embodiment of the present invention in GHZ 210 vs. S parameter magnitude in dB 205.

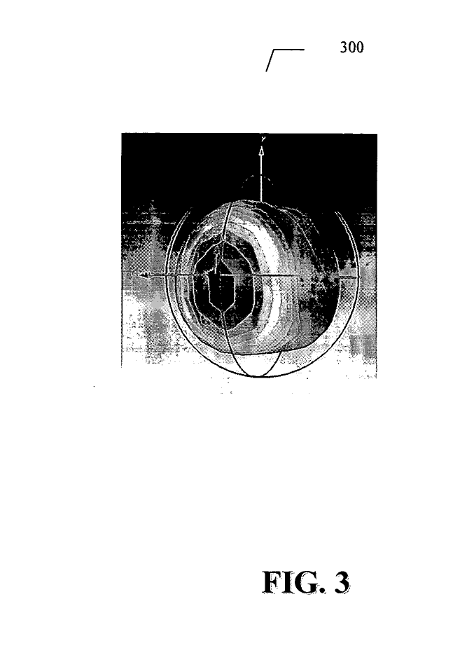

FIG. 3 depicts, at 300, a computed radiation pattern at 2.5 GHz of one embodiment of the present invention.

An embodiment of the present invention further provides a method of manufacturing an antenna, comprising printing a metallic component on a substrate, etching a main radiating slot into the metallic component, the main radiating slot fed by a coplanar waveguide, and etching at least one additional slot in proximity to the main radiating slot. This method may provide that the form factor of the slot antenna may be capable of being installed in the lid of a laptop computer and may be capable of providing bi-directional pattern with half-power beam width of 80° for each beam enabling the antenna to have angular coverage of about 160° in a single element. The method also allows the potential to print the antenna on the same printed circuit board of a radio transceiver associated with the antenna and also integrate a connector coupling with the coplanar wave guide.

In yet another embodiment of the present invention is provided a system for communicating in a Wireless Local Area Network, comprising, an access point, a wireless device capable of communicating with the access point, the wireless device including an antenna, wherein the antenna comprises: a substrate; a metallic component printed on the substrate; a main radiating slot etched into the metallic component, the main radiating slot fed by a coplanar waveguide; and at least one additional slot etched next to the main radiating slot.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An antenna, comprising:
a substrate;
a metallic component printed on said substrate;
a main radiating slot etched into said metallic component, said main radiating slot fed by a coplanar waveguide; and
at least one additional slot etched next to said main radiating slot.

2. The antenna of claim 1, wherein the form factor of said slot antenna enables it to be installed in the lid of a laptop.

3. The antenna of claim 1, wherein said slot antenna is capable of providing a bi-directional pattern with half-power beam width of 80° for each beam enabling said antenna to have angular coverage of about 160° in a single element.

4. The antenna of claim 1, wherein said antenna is on the same printed circuit board of a radio transceiver associated with said antenna.

5. The antenna of claim 1, further comprising a connector coupling said coplanar wave guide and a radiating source.

6. A method of manufacturing an antenna, comprising:
printing a metallic component on a substrate;
etching a main radiating slot etched into said metallic component, said main radiating slot fed by a coplanar waveguide; and
etching at least one additional slot in proximity to said main radiating slot.

7. The method of claim 6, further comprising enabling the form factor of said slot antenna to be installed in the lid of a laptop computer.

8. The method claim 6, wherein said slot antenna is capable of providing bi-directional pattern with half-power beam width of 80° for each beam enabling said antenna to have angular coverage of about 160° in a single element.

9. The method of claim 6, further comprising printing said antenna on the same printed circuit board of a radio transceiver associated with said antenna.

10. The method of claim 1, further comprising integrating a connector coupling with said coplanar wave guide.

11. A system for communicating in a wireless Local Area Network, comprising:
an access point;
a wireless device capable of communicating with said access point, said wireless device including an antenna, wherein said antenna comprises:
a substrate;
a metallic component printed on said substrate;
a main radiating slot etched into said metallic component, said main radiating slot fed by a coplanar waveguide; and
at least one additional slot etched next to said main radiating slot.

12. The system of claim 11, wherein the form factor of said slot antenna enables it to be installed in the lid of a laptop computer.

13. The system of claim 11, wherein said slot antenna is capable of providing bi-directional pattern with a half-power beam width of 80° for each beam enabling said antenna to have angular coverage of about 160° in a single element.

14. The system of claim 11, wherein said antenna is on the same printed circuit board of a radio transceiver associated with said antenna.

15. The system of claim 11, further comprising a connector coupling said coplanar wave guide and a radiating source.

16. The antenna of claim 1, wherein said antenna is capable of dual band operation.

17. The antenna of claim 16, wherein said dual band is dual-band in the frequency of 2.4 and 5.5 GHz and capable of operation in said bands simultaneously.
